(19) United States
(12) Patent Application Publication
(10) Pub. No.: US 2004/0015417 A1
(43) Pub. Date: Jan. 22, 2004

(54) Targeted marketing system

(76) Inventors: Roy D. Youngman, Alpharetta, GA (US); Steven W. Conley, Marietta, GA (US); Richard W. Lynch, Duluth, GA (US)

Correspondence Address: GREGORY SMITH & ASSOCIATES, 3900 NEWPARK MALL ROAD, 3RD FLOOR, NEWARK, CA, 94560, US

(21) Appl. No.: 10/616,182

(22) Filed: Jul. 8, 2003

Related U.S. Application Data
(60) Provisional application No. 60/394,045, filed on Jul. 8, 2002.

(51) Int. Cl. G06F 17/60

(52) U.S. Cl. 705/27; 705/26

(57) ABSTRACT

The present invention is a device and method for providing an interactive session with a customer in a retail environment. The invention provides a presentation to a customer in a retail environment that is customized to the unique interests of that customer.

### CROSSREFERENCE TO RELATED APPLICATIONS

Benefit of the priority of the Jul. 8, 2002 filing date of provisional application 60/394,045 is hereby claimed and incorporated herein by reference.

### FIELD OF THE INVENTION

This invention relates generally to product merchandizing and pertains more particularly to systems and methods for the promotion of products at a checkout counter.

### BACKGROUND OF THE INVENTION

Traditional in-store advertising provides generic advertisement based on broad customer demographics, hence they tend to be rather generic. This reduces the relevance they might have to any specific demographic segment of the customer base. If a message has specific content, they tend to be non-useful to most customers, who then learn to ignore subsequent messages

Many advertisements are static pictures or words on fixed frames. Many of these messages are broadcast to all customers and they are evolving to make use of dynamic images on electronic display units. Some channels, like television or radio have broad constituencies and by the nature of the medium cannot target a highly-defined type of customer.

Retailers have been using other channels to send messages to customers that offer more ability to provide relevant messages. Unfortunately, these channels are often poorly received by customers because they are perceived as intrusive. Examples of intrusive channels are direct mail, e-mail, and telemarketing since the customer is doing something else when they receive messages though one of these channels.

If the customer is going through their mail, they are often looking for letters from friends and family or processing financial statements and bills. Direct mail is often poorly received as a nuisance, interfering with that process, which has lead to the phrase “junk mail”. If someone is processing their e-mail, they are often in a work-related mindset. They are looking for information they have requested or information they need to guide their daily activities. Information they have not asked for or they don't need is often viewed as a waste of their valuable time, which has lead to the term “spam”. If someone receives a telemarketing call, they are always involved in another activity that the call interrupts, whether that be work, play, eating, or watching television. This is why the recent voluntary “no-call” program has had such a dramatic response in USA.

Another deficiency in current-art marketing is that many messages directed to customers cannot invoke customer interaction by their very nature. Traditional advertising creates content for customers to hear, but does not provide an easy means to let the customer respond. Television, radio, and direct mail are all limited to one-way messages from the retailer to the customer, which no interaction is possible or at least easily accomplished.

These current-art broadcast advertising approaches are very costly medium. Television and radio campaigns are expensive to create and to run. Direct mail campaigns have less, but significant creation costs and deployment cost, but also incur costs in acquiring and maintaining customer addresses. Telemarketing campaigns have labor costs and require maintenance of phone lists and an opt-out process. E-mail campaigns require the maintenance of e-mail addresses and also may require an opt-out process.

Many retailers today have difficulty retaining sales associates for long durations. As a result, whatever knowledge any one sales associate learns about any one customer is often lost to the retailer as soon as the sales associate leaves the company. In many multi-store retail chains, there is little knowledge about a customer to the sales associate while the customer is in the store. So opportunities are lost to recognize the loyalty of frequent shoppers or provide meaningful encouragement to customers to increase over all customer retention and frequency.

Internet shopping, or business-to-consumer e-commerce web sites, offer a new form of shopping experience. Several retailers have a significant web presence and some retailers are completely virtual. However, the vast majority of consumer spending is still occurring at physical retail outlets, with all trends indicating that physical store spending will always have a significant, if not majority share, or retail purchases in the foreseeable future. Most retailers today view e-commerce as another important sales channel, but not a replacement to their physical presence. Most retailers recognize that most of the opportunity to communicate with their customers occurs in their physical stores.

Many retailers have tried to introduce some form of kiosk electronic gadgetry in their stores designed to interact with customers, only to find the devices largely ignored or underutilized. Customers need a reason to utilize such a device to assist them in the process of selecting the product that brought them into the store. Most customers also need the device to be consistent with the way the customer is comfortable communicating.

What is needed is an innovative way to communicate with a customer while the customer is in the store, with messages that the customer finds useful and meaningful to his or her unique interests, at a place and a time that the customer is willing and able to communicate, in an interactive manner that allows the customer to respond, in a way that the infrastructure, campaign design, and campaign delivery is inexpensive, and in a way that customer knowledge is retained even as organizational changes occur. With this innovation, customer loyalty, retention, and frequency can all increase as quality campaigns are designed and deployed.

To summarize, what is needed is a means to have material presented to a customer that is customized to the unique interests of that customer.

### SUMMARY OF THE INVENTION

Aspects of the present invention answer the needs and problems found in the prior art. Utilizing low-cost infrastructure that is part of the sales and payment process, relevant messages to the customer are produced and presented while the customer is in the retail environment, identifiable and in a mindset consistent with receiving them. The messages may be interactive supporting customer responses to retailer inquires. Aspects of the invention preferably work with the point-of-sale process to ensure a high frequency of customer use. Using a device integrated into the point of sale process is preferred, in that it draws the attention of the customer to the messages. By providing meaningful, relevant messages using this device encourages high customer participation. Using low-cost messages allows the retailer to create and/or change advertising campaigns frequently, keeping them fresh and relevant to customer interests as well as seasonal changes.

The present invention is a device for the presentation of material of interest to the customer based on the information the system has about that customer. This presentation occurs during the check-out process within a store or in various department areas with a store. Associated with the device is a method that determines the selection and optimal placement of the material presented to the customer. The device and the method belong to a system that allows for one or more display tasks, transaction processing tasks, data collection tasks, and for the optimal management of system resources.

The customer display device, called a Customer Interaction Device (CID), contains one or more active screen areas where targeted presentation information and/or sales and payment transaction information may be viewed. The targeted presentation material can be customized to the customer based on at least one of several conditions including, but not limited to, the system knowing the identity of the customer, the previous and current purchasing history, geographic location of the customer's home, or information about the customer's demographics.

The system detects events of a sales transaction and current conditions and provides the framework for retailers to have one or more highly customizable workflows. A workflow is a series of steps that define how a task is to be completed. Each workflow can adhere to the different operational policies of the retailer, even when those policies are different based upon the location of the device inside a store. For example, the system allows a retailer to customize workflow actions during transaction states like the ones below:

What to do when a customer enters a bad PIN.

What to do when a customer can't remember a PIN.

What to do when a customer's signature is unreadable.

What to do when a customer's credit card is not approved.

What to do when a customer swipes a card but the track information is unreadable.

Decision to offer a Cash-Back option to debit card purchases or not.

What to do when a customer to disapproves a total verification request.

Other features and advantages of this invention will become apparent upon reading the following specification, which along with the drawings describes and discloses a preferred and alternative embodiment of the invention in detail.

### LIST OF DRAWINGS

A better understanding of the present invention will be had upon reference to the accompanying drawings in which like numerals refer to like parts in the several views and in which:

FIG. 1 contains the major system components

FIG. 2 is the screen area template for a CID display

FIG. 3 shows the system interconnection block diagram

FIG. 4 is reference diagram for customer interaction

FIG. 5 is a block diagram of the major system functions

FIG. 6 is the internal block diagram of a simple system

### DETAILED DESCRIPTION

The present invention makes available a new means of presenting information to a customer, and optionally collecting information from a customer, during a routine sales transaction within a store environment. Unlike traditional store advertising that may present generic advertisement based on broad customer demographics, the material presented using the present invention is likely to be of interest to this customer. The system is aware of the customer's identity and intelligently selects presentation material based on information such as previous purchasing history, the customer's income demographics, similar presentations that the customer has selected to view, or any other criteria meeting the merchant's criteria.

The material being presented on the display might be for, but is not limited to, promotions, services available by the merchant, upcoming community events, classes for training, or news. Interaction with the presentation by the customer allows the customer to obtain additional information, coupons, to be sent emails, or to take away customized printed material. Interaction with the presentation by the customer also allows the customer to provide information to the system such as, but not limited to, zip-codes, telephone numbers, email addresses, answers to marketing questions, or any other information the merchant wishes to obtain from the customer.

For purposes of this invention, an electronic display device shall mean an electronic device that has the capability of providing character images and/or graphical images that can be seen by the human eye. There are a variety of technologies for electronic display devices that are may be used in this invention and they include, but are not limited to, Liquid Crystal Displays (LCDs), Cathode Ray Tubes (CRTs), Plasma display, Micro Electo-Mechanical Mirrors (MEMs), Image Projection systems, and Fiber Optic display systems.

While the preferred embodiment of this invention relies on a display device for presentations to the customer, alternate embodiments would include audio output, RF signals to devices a customer might poses, mechanical or vibration systems to communicate through touch for customers that rely on Brail communication, printed Brail, or smell when such technology permits. Combinations of such alternate embodiments would be still further alternate embodiments.

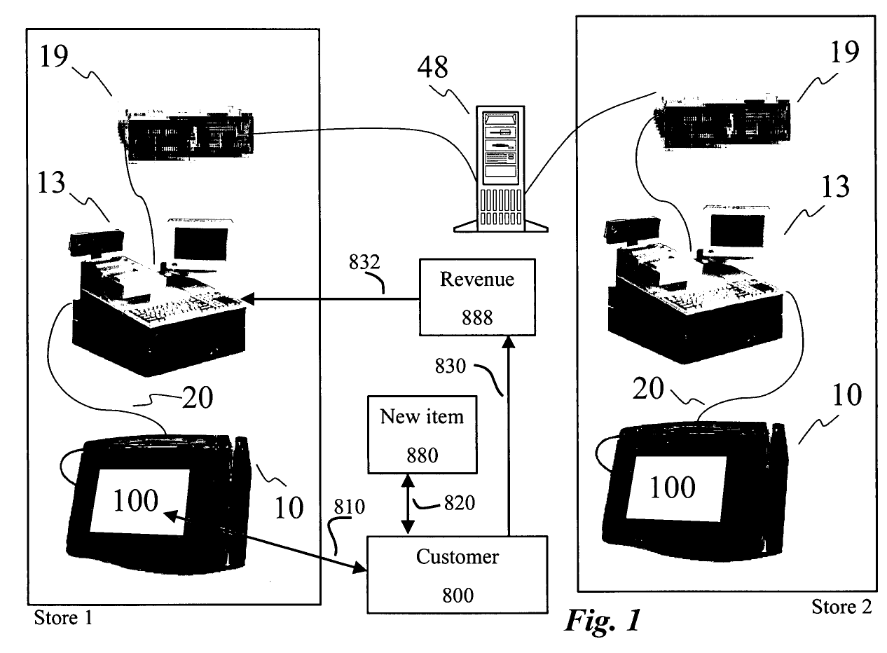

The major parts of the Personalized Real-Time Interactive Store Middleware (PRISM) system are shown in FIG. 1. Within the store may be the Customer Interaction Device (CID) 10, the Pont of Sale (POS) terminal 13, and the store system controller 19. The system may be used in a single store operational mode or have multiple stores connected together and make use of some centralized management system 48. In this embodiment, CID 10 is directly connected to POS 13 via communication cable 20.

In the preferred embodiment, the CID is used during the transaction session at the checkout area. An alternate embodiment has the CID in a department area of a store providing customer guidance during the selection of merchandise, as an information device for an individual while other members of the shopping group are busy in a department, or as an introduction device as a customer enters the store.

CID 10 provides the display that can have various screen areas available for providing the sales transaction information, targeted presentations, and/or solicitation area so the customer may obtain more information. In the preferred embodiment, the CID also contains a card reader for credit/debit cards, customer loyalty cards, or store cards. It would have an electronic pen for the customer to be able to provide a signature, used in pointing to areas during the presentation for selecting points of interest, or tapping an area on the display to initiate activities such as printing take-away material.

In alternate embodiments, the CID might contain connections to an optical scanner to provide identification of the customer, products, or promotional material such as coupons or referrals. In further alternate embodiments, the CID might contain electronic scanners to receive radio frequency signals that provide a customer's identification, product identity, or promotional referrals. These signals might be part of a system that makes use of a Personal Digital Assistant (PDA), Radio Frequency Identification device (RFID), or a cell phone. In still further alternate embodiments, the CID might contain a numeric or alphanumeric keypad for entry of Personal Identification Numbers (PINs), cash back amounts, customer loyalty number, or entry of the customer's email address.

In the preferred embodiment, CID 10 may directly or indirectly provide output information to the customer. The output may be, but is not limited to, information to be displayed in the screen areas, printed on a local printer, printed on a remote printer that then mails the information to the customer, electronic mail directed to the customer, cell phone messages, telephone reminder messages, messages directed to the customer's PDA, or information forwarded to other interested parties.

The CID display is composed of one or more screen areas and the display is not restricted to a single physical size, display resolution, or technology. Within a retail environment, there may be a variety of display sizes operating concurrently. In the preferred embodiment, a presentation to be displayed need not be customized for each display size or customized so that multiple presentations may occur simultaneously in different screen areas on a single display.

The flexible usage of the display is accomplished by the system using the Screen Management function. Simply put, the goal of the Screen Management function is to optimize the timing and placements of presentations to maximize the information conveyed to the customer. There are two phases to accomplish the Screen Management function, the selection of at least one of a plurality of presentations and the customization of the content for the specific customer and the CID display capabilities.

A presentation can be associated with a transaction phase to show the presentation at a specified time before, during, or after a transaction. A customer may belong to one or clusters and optionally receive a presentation. A cluster is an identifiable market segment of a retailer's customers that has been selected to receive one or more presentation. For example, a customer may have been selected because of a previous purchase indicating an interest in a sport such as soccer, by their home location such as on a lake, or by household income. The screen manager uses clusters to calculate the presentations to show. Additional clusters can be determined by who the consumer is (through the credit card swipe) or by the products they have purchased.

There are several special types of clusters. These clusters are always defined in the system. They may optionally have one or more presentations associated with them.

Birthday Cluster—Used to group presentations that are targeted to customers whose birthdays are close to the current date.

Idle Loop Cluster—Used to group presentations that are presented during the Idle Loop Phase. The Idle Loop Phase occurs when no Customer is detected by PRISM.

Broadcast Cluster—Used to group presentations that are broadcasted to every customer.

Default Cluster—Used to group presentations that may be delivered to customers that are not identifiable. The Default Cluster does not come into play in the course of a Customer session until after PRISM has had a chance to identify the customer (i.e., a card swipe). When PRISM determines that the customer is not on record, the presentations assigned to the Default Cluster are allowed to be viewed.

Non-Targeted Cluster—Used to group presentations that may be delivered to customers that are identifiable, but are not targeted for any other presentations. The Non-Targeted Cluster does not come into play in the course of a customer session until after PRISM has had a chance to identify the customer (i.e., a card swipe). When PRISM determines that the customer is on record and that the customer is not assigned to any general purpose targeted Clusters, the presentations assigned to the Non-Targeted Cluster are allowed to be viewed.

No advertisements Cluster—Members of this cluster will receive no advertising presentations.

The end result of this invention of targeted marketing is revenue for the retailer. A method associated with the present invention presentation is then:

a) Customer 800 views the presentation using the apparatus of the system of the present invention on screen area 100 of CID 10.

b) At some point in time, customer 800 selects new product item 880 that would not have been selected by said customer if the presentation had not been viewed.

c) Said customer provides some form of payment 830 which provides revenue 888 for the retailer.

For the purposes of this invention, a presentation is considered to be a single package of information to convey a specific message to a customer. A presentation may include graphical images, fixed text for all viewers of the presentation, or dynamic text that is customized to the individual viewer of the presentation (e.g. the customer's name). A presentation may optionally include an opportunity for the customer to interact with the presentation.

Graphical images can be any definition of computer graphics including all forms of bitmap, raster-based, or vector-based formats. Multiple graphical images may be included in a single presentation and the system may optionally adjust the quality of the image for the best optimization of screen quality, communications resources, and system loading.

A presentation may have text displayed in a screen area. The text may be sent from the system in character format or as series of graphical images. Some text of the presentation my be assigned to all viewers of that presentation and some text is dynamically customized by the system through the use of a string substitution algorithm. An example of this would be to say “Welcome to the store John Doe!” where John Doe is the user that has swiped his card. The text string in the database would look like “Welcome to the store &firstname; &lastname;!”. The algorithm will substitute the &firstname; with the consumer's first name.

A presentation may optionally include action areas that provide an opportunity for the customer to interact with the presentation. These input sources can be from, but not limited to, a touch screen, infrared signal from a PDA, RF signal from a cell phone, keypad, speech recognition, or other input technologies. Uses of this input may be for selection of additional presentation information, activate a system output event, or providing personal information such as an email address.

A system output event may optionally occur. Such an event might be, but is not limited to, providing specific directions to a fashion show on a local printer, providing an email address for when an item goes on sale, sending an infrared signal to a PDA providing a calendar reminder of a class at the store, an RF signal to the phone for the pharmacy phone number, or printing customized advertisements on a remote printer that is then mailed to the customer's home.

The CID's display allows multiple presentations to be displayed at the same time, providing there is room on the screen. This means that there must be a way for the system to determine where on the screen it should display any one presentation. There is a concept of a Screen Template that has a specific organization of rows and columns used to define the placement of presentations on the CID. In the preferred embodiment, all cells of a Screen Template must be the same size but alternate embodiments of non-uniform size cells are possible.

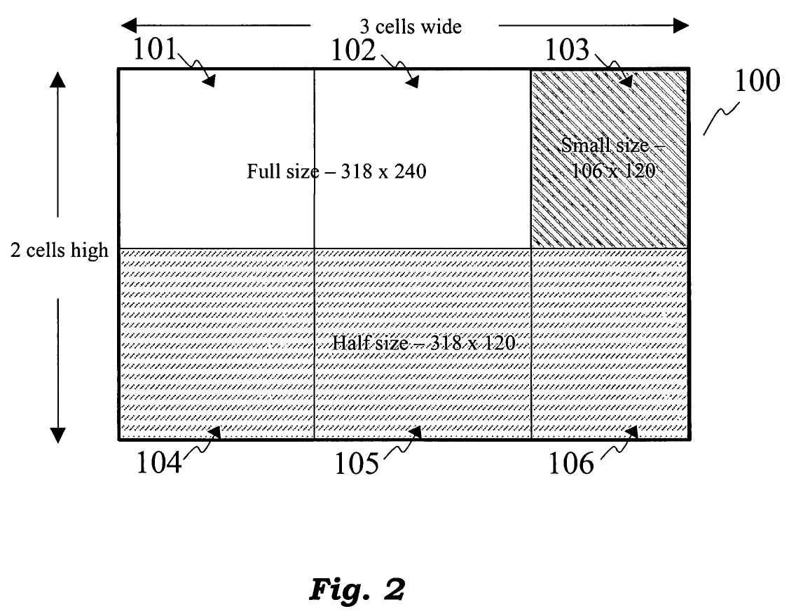

Shown in FIG. 2 is a preferred embodiment for a CID's display (100) which has a display screen resolution of 318 pixels wide by 240 pixels tall. The display is subdivided into preferably six screen areas (101-106) in which the presentation designer may choose a screen area layout containing one or more of these areas. Should more than one area be selected by the presentation designer, these areas need not be adjacent to each other.

Once a decision is made on a Screen Template, the presentation may be designed to fit preferably any combination of cells. The presentation can be created portrait-oriented, landscape- oriented, or square-oriented. Examples of Screen Template formats for presentations may be, but not limited to:

Full Size: Landscape presentations that use the full 318 pixels×240 pixels screen (101-106).

Half Size: Landscape presentations that use half of the screen (318 pixels×120 pixels) (104-106).

Small Size: Square presentations that fill one cell (106 pixels×120 pixels) (103).

While presentations may be used in one or more screen areas, other areas may be concurrently used for items being scanned, customer signature area, keypad display for touch screen entry, or solicitation buttons for selection of additional information. These screen tasks may operate independently or may be related to each other.

The system maintains a dynamic list of candidate presentations to display. The list can grow as the customer is identified and the clusters the customer is associated with are determined. The list can grow as products are identified and the clusters the products are associated with are determined. The list can shrink as presentations are displayed and the rules assigned to the presentations indicate their removal after being acknowledged or ignored by customers.

The total size of the list is kept below a configurable limit to minimize the chance of overwhelming the customer. The priority of any presentation in the list is dynamically changed depending upon the importance of the cluster that generated the presentation in the first place, the last time it was displayed, and the response of the customer to the presentation when it was last shown (if any). When the duration of a presentation expires, the system determines how to optimally utilize the screen space for the next presentation in the list that can use the space that has the highest dynamic priority.

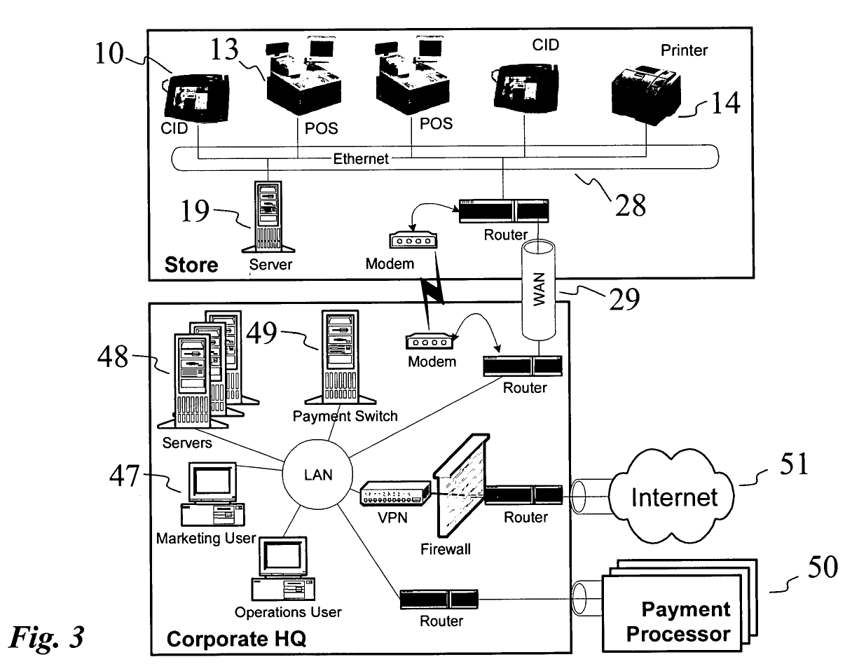

Shown in FIG. 3 is a preferred embodiment of the targeted marketing system invention. It consists of CID 10 connected to store network 28. Also connected to said network is printer 14 responsive to processing system 19 allowing information to be printed that the customer desired to take from the store. Point of Sale (POS) terminal 13 provides traditional check-out and cash register functions.

CID 10 and POS 13 can directly communicate with each other for some tasks and for other tasks they may use the processing capabilities of 19 to perform more complex inter-related tasks. For example, the PRISM system knows the “state” of the sales or payment process and the “workflow” being performed and can thus affect what is selected and shown on said CID.

One or more store processing systems may optionally communicate with a corporate processing system through communications link 29. Such a corporate network may provide payment processor 49 that maintains payment transactions and route it to external payment processor system 50 for the transfer of funds. Marketing may create customer presentations or create customer clusters on processor 47. Email may be sent to the Internet (51) or information can be received from it to directly or indirectly be displayed on CID 10.

The most important transaction that ever occurs in a store is the sales and payment transaction. So a retailer must be confident that any form of customer interaction that is not related to the sales or payment transactions does not in any way interfere with this sales or payment transaction. This is especially true when the same device is used in the sales, payment, and customer interaction processes. For example: the system knows when a sale is in the “pre-total” state and when it enters the “post-total”. When in pre-total, a campaign can be designed to show presentations that coexist nicely with a customer display (scrolling receipt). But when the state changes to post-total, these presentations have a lower priority than the content that needs to be displayed in order to complete the payment transaction (like a cash-back option, an Approve Total, a PIN Pad, or a Signature Capture Control).

The system allows a retailer to set up multiple workflows and designate any CID to use any one of them. Beyond that, the PRISM system allows retailers to create multiple workflows so different devices can have different workflows based upon their location. For example, a discount superstore might have a different workflow for their front lanes versus their electronics department.

The system allows multiple interactions to occur simultaneously. The PRISM system can display more than one presentation at a time in multiple areas on the CID display. This way, a customer display (scrolling receipt) can be displayed at the same time that two other promotions are being displayed. This allows the PRISM system to interact with the customer while the sales and payment transactions take place, utilizing the time that the customer is otherwise waiting and looking at a largely blank screen.

Intelligent screen management dynamically adjusts what content is displayed throughout the transaction. The campaign designer(s) set up rules that get to handle major issues such as:

What happens when there are multiple relevant things to display, and not enough screen space?

Over time, when should something on the screen give way to something else?

When something has already been displayed, should it be displayed again?

Should it be displayed again even if the customer acknowledged it previously?

What if the customer ignored certain content?

How many different promotional presentations should be shown before risking “customer-overload”?

The system determines relevant content to display to a customer. By assigning presentations to clusters, and by assigning membership to clusters in the form of customers, households, or products, the system can determine what presentations are relevant during a customer interaction session whenever a payment card is detected, a loyalty card is detected, or a product is detected. The clustering of customers, households, and/or products in a way that any detected customer or product can result in relevant presentations being displayed is what is meant by “Cluster Management”.

The workflow within the system of the present invention is a sequence of steps that are performed in response to a customer interaction event. The result of said workflow is a sales event or a customer interaction. Unlike current art systems that have the sequences determined by the manufacturer or system specialist, the present invention provides for the workflow system to be dynamically configurable by the merchant in a sequence of customizable sessions determined by the type of event and the current set of conditions.

A customized workflow is comprised of multiple workflow steps. Each workflow step has three parts. First, a workflow step identifies an event that the system can detect. Second, a workflow step identifies the conditions the system can check to see if they exist at the time the event occurs. And third, a workflow step identifies the resulting tasks that the system will perform when the event is detected and the conditions are all true.

In the preferred embodiment, the system detects the following events:

Item Purchase—According to the POS, an item has been purchased.

Total—The POS has totaled the sales transaction in preparation for payment.

Card Swipe Bad—A Card Swipe occurred on the terminal but had an unsuccessful read.

Card Swipe Good—A successful Card Swipe occurred on the terminal or was supplied to the system by the point-of-sale. Upon a good card swipe, the system will determine if the card that was swiped was a payment card or a loyalty card. If the card was a loyalty card, the system will attempt to match the card number to a customer identity.

If the card was a payment card, the system will encrypt the card number with a non-reversible encryption technique and attempt to match the encrypted card number to a customer identity. Anytime the system does determine a customer identity, the system will attempt to determine the household the customer belongs to.

The system then determines all the clusters that both the customer and the household belong to, and all the presentations currently active for each associated cluster. The system will place all associated presentations in the presentation queue where the system's screen management processes will determine the sequence, priority, duration, size, and screen location of the presentations based on the current phase of the transaction and the passage of time.

Cash Back Amount Chosen—The customer has selected a Cash-Back option.

PIN-Pad Cancel—The customer hit the cancel button on the PIN-pad.

PIN-Pad OK Good—The customer hit the ok button on the PIN-pad.

SigCap Cancel—The customer hit the cancel button on the signature capture. Begin Transaction—The POS has indicated the start of a sales transaction.

SigCap OK Good—The customer hit the ok button on the signature capture.

POS Registered—The POS has registered with a connected terminal running the system.

Total Acknowledge Approved—The customer has approved the total displayed on a Total Approval Presentation.

Total Acknowledge Disapproved—The customer has disapproved the total displayed on a Total Approval Presentation.

CC Inquiry Approval—An authorization for a credit card purchase is approved.

CC Inquiry Decline—An authorization for a credit card purchase is declined.

Debit Inquiry Approval—An authorization for a debit card purchase is approved.

Debit Inquiry Bad PIN—An authorization for a debit card purchase is declined because the supplied PIN was incorrect.

Debit Inquiry Decline—An authorization for a debit card purchase is declined.

CID Registered and Ready—The Customer Interactive Device (CID) is now registered with the system and is ready.

SigCap OK Bad—The customer's signature did not register within defined parameters of what is considered a reasonable rendering of a signature.

Those skilled in the art will appreciate that other types of events are possible in the preferred embodiment and those alternate embodiments are within the teachings of this invention.

There are several different types of conditions that the system checks when an event is detected before invoking a corresponding task. Because the system checks all these different types of conditions, whether an event invokes one response, or whether the same event invokes a different response, can be defined very precisely. The following list describes the various types of conditions the system monitors and the values that can be assigned to a workflow step:

Payment Type—Indicates what form of payment the customer is using to tender the transaction. The system automatically determines the current payment type whenever the customer has successfully swiped a payment card or if instructed by the POS. Acceptable values when setting up a workflow step include:

Dash (-)—Any type of payment

Credit

Debit

Cash

Card Swiped?—Indicates if a successful payment card swipe has occurred. Acceptable values when setting up a workflow step include:

Dash (-)—Either way

Y—Yes

N—No

PIN Retries Maxed?—Indicates if the customer has submitted a debit payment that was declined because of an incorrect PIN more than a configurable number of allowable attempts. Acceptable values when setting up a workflow Step include:

Dash (-)—Either way

Y—Yes

N—No

SigCap Retries Maxed?—Indicates if the customer has attempted to enter a signature for a credit payment that was rejected as being an incorrect signature rendering more than a configurable number of allowable attempts. Acceptable values when setting up a workflow Step include:

Dash (-)—Either way

Y—Yes

N—No

Customer Known?—Indicates if the system has been able to identify the customer currently using the channel. Acceptable values when setting up a workflow step include:

Dash (-)—Either way

Y—Yes

N—No

Card Swipe Retries Maxed?—Indicates if the customer has attempted to swipe a card more than a configurable number of allowable attempts. Acceptable values when setting up a workflow step include:

Dash (-)—Either way

Y—Yes

N—No

Phase—Indicates the current phase of a customer interaction. Acceptable values when setting up a workflow step include:

Dash (-)—Any phase

Idle—There is no sales transaction underway and no indication of a customer present.

Pre-Total—A sales transaction has begun, but has not been totaled.

Post-Total—A sales transaction has begun, has been totaled, and payment is occurring.

Post-Sale—Both the sales transaction and payment transaction are complete but another sales transaction has not started and the customer is assumed to still be present. The maximum duration of the Post-Sale phase can be customized by a configuration parameter.

These exemplary conditions of the preferred embodiment are only some of the possible conditions that can exist. Alternate embodiments are possible with only some of the conditions of this list and still more embodiments are possible with additional conditions.

After an event of a workflow step is detected, and all the conditions of the workflow step are true at the time the event occurs, then the task defined in the workflow step will be invoked by the system. The following list describes the various tasks that the system can invoke when assigned to a workflow step:

Arm Card Swipe—The system will try to read a card if a swipe occurs.

Begin Idle—The system will change the Phase to Idle.

Begin Post-Sale Phase—The system will change the Phase to Post-Sale.

Disarm Card Swipe—The system will no longer try to read a card if a swipe occurs.

Display PIN pad control—The system will display the debit PIN-Pad control.

Display Presentation—The system will display a custom selected presentation.

Display Receipt Control—The system will display the customer display receipt control.

Display signature capture control—The system will display the signature capture control.

End transaction—The system will terminate the current sales transaction.

Expire PIN pad control—The system will expire the debit PIN-Pad Control.

Expire Presentation—The system will expire whatever custom presentation you select.

Expire receipt control—The system will expire the customer display receipt control.

Expire signature capture control—The system will expire the signature capture control.

Process payment info for archival—The system will submit the payment transaction for signature compression and archival.

Request credit approval—The system will submit a credit payment transaction for approval.

Request debit approval—The system will submit a debit payment transaction for approval.

Return to Pre-Total Phase—The system will change the current phase to Pre-Total.

Force payment as credit—The system will treat a payment card that was detected as debit as if it were credit.

Print Presentation on Printer—The system will print a custom selected presentation.

When a workflow step invokes a task that displays or expires a presentation, the customized presentation is also defined by the workflow step. Any task that will end up displaying something on the screen needs a corresponding priority so the system can make good decisions of what to display when more things want to be displayed then the screen has room for. All such priorities for workflow steps are assigned a priority greater than the maximum possible dynamic priority a regular presentation can ever obtain, thereby ensuring that any request for screen space from a workflow steps takes priority over regular presentations. Each workflow step is assigned a task sequence value, allowing the system to sequence the order of tasks when the same event invokes multiple tasks under the same set of conditions. The lower task sequences are performed first.

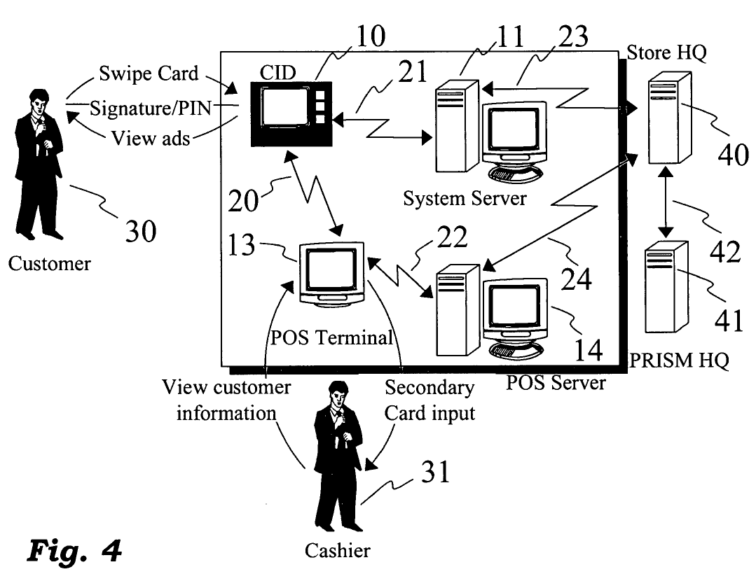

Shown in FIG. 4 is a schematic view that will aid in understanding the transaction sequence that makes use of this invention. Customer 30 brings items to be purchased to a retail check-out counter. CID 10 may be providing generic advertisements that are not customized for said customer. Cashier 31 may request that said customer provide some form of identification so the system can identify proper advertisements. This identification might be a customer loyalty card for example.

CID 10 sends the electronic identifier for said customer to System Server 23 though communications link 21. Said Server determines the appropriate presentation(s) for said customer from a plurality of available presentations and sends said presentation to said CID.

Point of Sale (POS) terminal 13 used by said Cashier may have a UPC scanner to read the product identifier that said customer is purchasing. Product and price information may be directly sent to CID 10 through communications link 20 or through alternate communications paths that allow said CID to display product information in specified screen areas. Such product information may optionally be sent to Server 23 which might provide alternate presentations to Customer 30.

When payment for the products being purchased is requested, CID 10 may optionally provide the means to read a credit or debit card. Said CID may optionally have a touch sensitive area allowing the customer to provide a signature often required in credit card purchases.

If the presentation allows for customer directed inquires, CID 10 may also provide a means to alert the system server for special services. These services may include, but is not limited to, printing of store special sales, directions to community events, email reminders, or suggestions for useful products based on the special circumstances of said customer.

The retail operations policy owners determine how they want the workflows to work based upon operational policies and the location of the devices in the stores. They create one or more customized workflows with all workflow steps and the method associated with this invention:

d) A separate set of configuration variables, called a CID configuration, is created for every different use of a CID throughout the retail enterprise. Each CID Configuration is assigned to a specific workflow.

e) Every CID is assigned to one specific CID configuration.

f) When the system starts, each CID registers itself which results in the system recognizing the specific CID configuration and also the specific workflow that the CID is assigned.

g) When an event is detected by the system, each workflow step of the CID's assigned workflow is examined:

h) If the event is not listed in any workflow step, then the event is ignored.

i) If the event is listed in a workflow step, then the conditions or the workflow step is checked.

j) If the conditions of the workflow step are not all valid, then the workflow step is ignored.

k) If the conditions of the workflow step are all valid, then the task associated with the step is invoked.

l) When the same event invokes multiple tasks, they are invoked in task sequence order.

m) Workflow steps that invoke tasks to display a presentation on the screen are prioritized and given a priority higher than any regular presentation. A workflow generated presentation immediately causes the system to recalculate screen usage priorities so that workflow generated presentations get immediate screen real-estate.

n) A presentation that was generated by a workflow task will remain on the screen until another workflow step invokes a task to expire it, or until a new transaction begins.

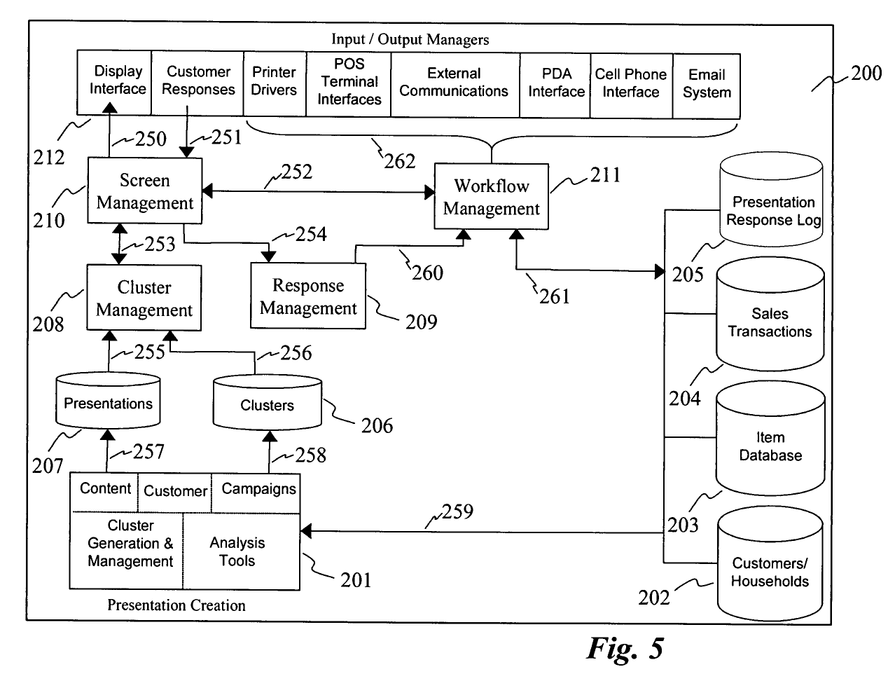

The major functions implemented by the system are shown in FIG. 5. These functions can be implemented in hardware, software, on a single computer, or distributed over multiple computers. The important aspect of this invention is that these functions work together to achieve the desired result of interacting with a customer as described previously.

A computer as used herein will include, but is not limited to, at least one instance of a member of the collection comprising an instruction processor, an inferential engine, and a finite state machine. The instruction processor includes at least one instruction processing element and at least one data processing element, each data processing element controlled by at least one instruction processing element.

The memory referred to herein includes at least one instance of at least one member of a memory type collection comprising: a non-volatile memory, and a volatile memory. A non-volatile memory includes at least one memory state retained without applying a power source to the non-volatile memory. The volatile memory includes at least one memory state lost without applying the power source to the volatile memory.

The desired goal of a campaign is implemented using presentations that are created by function 201. These presentations may be generic in nature or a presentation that is targeted to reach selected one of more clusters of customers. Analysis tools may be used to determine the number of customers that can be targeted so that an optimum arrangement of development resources can be balanced with the desired result. The cluster demographics and presentation priority information is stored in function 206.

Besides defining cluster membership, function 201 also generates the base presentation. Said presentation may contain graphical material, real-time information fed from alternate sources, static text, dynamic text, and instructions that allow for the customer to interact with the presentation to direct the material being displayed or requests for other actions, or printing of material to be given to said customer. Said presentation is then stored in function 207.

The system functions interact with a variety of input and output devices through specified interfaces identified generically as function 212. Screen Management function 210 determines the optimum management of information for the display on the CID. Function 210 interacts with Cluster Management function 208 to select the retrieval of the optimum presentation for the customer from the plurality of presentations stored in function 207. Function 210 directs the selection process as specified for each campaign presentation which may be based on specific combinations of customer demographics, products purchased demographics, or generic information for customers of that store.

Screen function 210 brings together base presentation 207 and transaction information, provide the final information for display in the CID screen area. At this point, graphical images may be adjusted in consideration of the display capabilities of CID 10, generation of final text from dynamic text fields, and considerations made for the capabilities and cost of transmitting the information over the communications network.

Workflow Management function 211 provides the sequence of steps necessary to complete all the transactions for the customer. Function 211 communicates with Screen Management function 210 to coordinate the display activities and obtain customer triggered events. In sequencing through presentation steps and purchasing transactions steps, function 211 may store transaction activities in the Response Transaction Log function 205, Sales Transaction log 204, make use of Item Database function 203, or Customer Database function 202.

Workflow Management function 211 may receive additional information from external devices through interface 232 to help direct its activities. Function 211 may also need to provide information to external devices or functions. If part of the workflow sequence requires that it print information requested by a customer, it may direct output to a printer. If the workflow sequence requires the customer to receive an email reminder, Workflow Management may direct that an email be sent through the internet to a specified recipient.

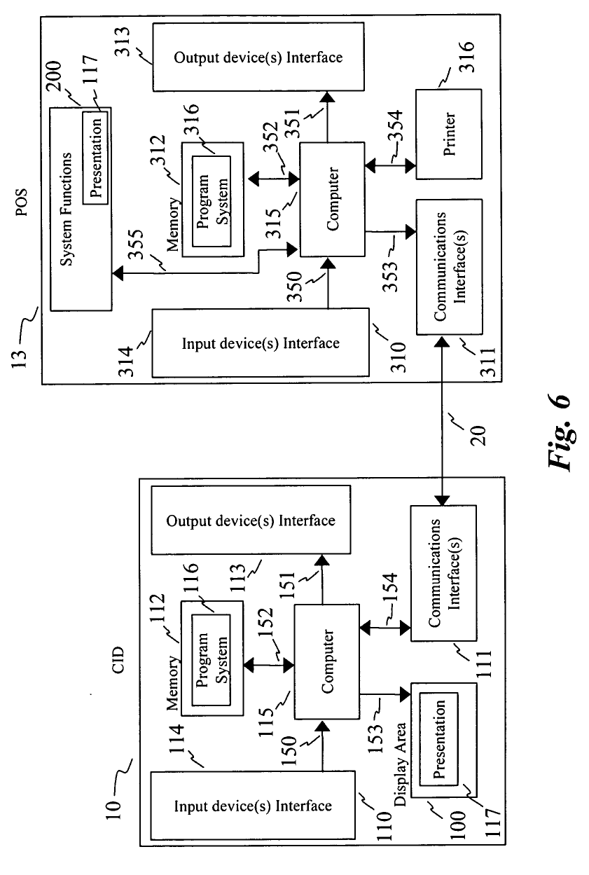

One of the simplest embodiments of the present invention is shown in FIG. 6. This embodiment has CID 10 connected to POS 13 which contains traditional POS terminal functions such as cash register, printer, and keypad, but also contains system functions 200 of the present invention.

Within CID 10 is computer 115 and for purposes of this invention, a computer is defined as a apparatus that has at least the capability to do a conditional sequence of steps, is a finite state machine, or is an inference engine. Said computer provides the ability to display presentation 117 on display area 100 after receiving said presentation through communications block 111 over communications link 20.

As mentioned previously, some embodiments CID 10 have the ability to attach additional input sources through input device interface block 110. Such input sources can be, but is not limited to, touch sensitive screen sensing, RF receivers for customer identification, infrared receiver for PDA signals, or keyboard.

Also, as mentioned previously, some embodiments CID 10 have the ability to attach additional output devices through output device interface block 113. Such output sources can be, but is not limited to, printer, RF transmitter for information to be sent to a cell phone, or infrared transmitter for PDA signals.

Although exemplary embodiments of the invention have been described in detail above, those skilled in the art will readily appreciate that many additional modifications are possible without departing materially from the novel teachings and advantages of the invention. For example, the system may be used in a pharmacy where the system can provide information on medicine, related supplies for treatments, and collection of information to meet regulatory requirements.

What is claimed is:

1. A system for the presentation of specific marketing presentations to customers in a retail environment, comprising:
an electronic display device providing at least one electronic presentation to a customer in said retail environment;
a processing system providing said electronic presentation for said electronic display device;
means for said processing system to electronically deliver said electronic presentation to said electronic display device; and
means for selecting a presentation from at least two presentations based upon the unique interests and needs of said customer to make available said electronic presentation to said processing system.

2. The system of claim 1, wherein said electronic display device has at least one screen area that can be used for information associated with a product purchasing transaction.

3. The system of claim 1, further comprising: means for a Point of Sale Terminal to communicate price information about at least one product being purchased to said system.

4. The system of claim 1, further comprising: means for said customer identifying themselves to said system as an identified customer.

5. The system of claim 4, wherein said electronic presentation includes at least one customized electronic presentation based upon said identified customer and based on at least one targeted campaign objective.

6. The system of claim 4, further comprising at least one member of the collection comprising:
means for said identified customer interacting with said electronic presentation to create at least one customer interaction;
means for generating electronic or printed messages initiated by said customer interactions;
means for logging said customer interaction to provide later desirable information regarding said identified customer;
means for logging at least one of said products purchased by said identified customer to provide later desirable information to said customer.

7. The system of claim 1, further comprising at least one member of the collection comprising:
means for said customer interacting with said electronic presentation to create at least one customer interaction;
means for generating electronic or printed messages initiated by said customer interactions.

8. The system of claim 7, further comprising: means for logging said customer interaction to provide later desirable information regarding said customer.

9. Said presentation of claim 8, wherein said presentation is customized by information previously stored about at least one product purchased by said customer.

10. The system of claim 1, further comprising: means for a Point of Sale Terminal to communicate a unique product identification code to said system.

11. The system of claim 10, further comprising: means for logging at least one of said products purchased by said customer to provide later desirable information to said customer.

12. Said presentation of claim 11, wherein said presentation is customized by information previously stored about said customer.

13. A first function to create at least one of said presentations used by said means for selecting of claim 1.

14. A second function that creates at least one cluster that specifies demographics;
wherein said customer of claim 1 has at least one of said demographics; and
wherein said means for selecting further includes means for selecting said presentation based upon said demographics of said customer matching said demographics of at least one of said clusters.

15. Said second function of claim 14, wherein said cluster is derived by information previously stored about said customer.

16. Said second function of claim 14, wherein said cluster is derived by information previously stored about at least one product purchased by said customer.

17. Said system of claim 1, further comprising: means for said customer to interact with the purchasing transaction.

18. Said system of claim 1, further comprising: means for said customer to interact with the payment transaction.

19. A method for the presentation of specific marketing presentations to customers in a retail environment, comprising the steps of:
providing at least one electronic presentation to a customer by an electronic display device in said retail environment;
providing said electronic presentation for said electronic display device by a processing system;
electronically delivering said electronic presentation to said electronic display device from said processing system; and
selecting a presentation from at least two presentations based upon the unique interests and needs of said customer to make available as said electronic presentation to said processing system.

20. The method of claim 19, wherein said electronic display device has at least one screen area that can be used for information associated with a product purchasing transaction.

21. The method of claim 19, further comprising the step of: a Point of Sale Terminal communicating price information about at least one product being purchased to said system.

22. The method of claim 19, further comprising the step of: said customer identifying themselves as an identified customer.

23. The method of claim 22, wherein said electronic presentation includes at least one customized electronic presentation based upon said identified customer and based on at least one targeted campaign objectives.

24. The method of claim 19, further comprising the step of: said customer interacting with said electronic presentation to create at least one customer interaction.

25. The method of claim 24, further comprising the step of: generating electronic or printed messages initiated by said customer interaction.

26. The method of claim 24, further comprising the step of: logging said customer interaction to later provide desirable information regarding said customer.

27. Said customer interaction, as a product of the process of claim 24.

28. The method of claim 19, further comprising the step of: a Point of Sale Terminal communicating a unique product identification code to said system.

29. The method of claim 28, further comprising the step of: logging at least one of said products purchased by said customer to later provide desirable information regarding said customer.

30. Said desirable information as a product of the process of claim 29.

31. A method of making said presentations used by the step of selecting of claim 19, comprising the step of: a first function creating at least one of said presentations used by the step of selecting.

32. The method of claim 31, wherein the step of said first function further comprising the step of: customizing said presentation by information previously stored about said customer.

33. The method of claim 31, wherein the step of said first function further comprising the step of: customizing said presentation by information previously stored about at least one product purchased by said customer.

34. A method of creating demographics, comprising the step of a second function creating at least one cluster that specifies demographics;
wherein said customer of claim 19 has at least one of said demographics; and
wherein the step selecting further includes the step of:
selecting said presentation based upon said demographics of said customer matching said demographics of at least one of said clusters.

35. The method of claim 34, wherein said cluster is derived by information previously stored about said customer.

36. The method of claim 34, wherein said cluster is derived by information previously stored about at least one product purchased by said customer.

37. The method of claim 19, further comprising the step of: said customer interacting with the purchasing transaction.

38. The method of claim 19, further comprising the step of: said customer interacting with the payment transaction.

39. Said electronic presentation provided by said electronic display device to said customer in said retail environment, as a product of the process of claim 19.

40. Said presentation made available as said electronic presentation to said processing system, as a product of the process of claim 19.

41. Said electronic display device of claim 19, providing the means for implementing the step providing said electronic presentation to said customer in said retail environment.

42. A method of using a Customer Interaction Device (CID) by a customer, including the steps of:
providing said customer at least one electronic presentation on said CID in a retail environment; wherein said electronic presentation is based upon the unique interests and needs of said customer;
said customer viewing said electronic presentation on said CID;
said customer selecting at least one new product item based upon said electronic presentation to create a selected new product item at some point in time; and
said customer paying for said selected new product item to create a revenue.

43. Said selected new product item as a product of the process of claim 42.

44. Said revenue as a product of the process of claim 42.

45. The method of claim 42, wherein said electronic display device has at least one screen area that can be used for information associated with a product purchasing transaction.

46. The method of claim 42, further comprising the step of: said customer identifying themselves as an identified customer.

47. The method of claim 46, wherein said electronic presentation includes at least one customized electronic presentation based upon said identified customer and based on at least one targeted campaign objectives.

48. The method of claim 42, further comprising the step of: said customer interacting with said electronic presentation to create at least one customer interaction.

49. The method of claim 48, further comprising the step of: generating electronic or printed messages initiated by said customer interaction.

50. The method of claim 48, further comprising the step of: logging said customer interaction to later provide desirable information regarding said customer.

51. Said customer interaction, as a product of the process of claim 48.

52. The method of claim 42, further comprising the step of: a Point of Sale Terminal communicating a unique product identification code to said system.

53. The method of claim 52, further comprising the step of: logging at least one of said products purchased by said customer to later provide desirable information regarding said customer.

54. Said desirable information regarding said customer as a product of the process of claim 53.

55. A method of making at least one of said presentations used by the step of selecting of claim 42, comprising the step of: a first function creating at least one of said presentations.

56. The method of claim 55, wherein the step of said first function further comprising the step of: customizing said presentation by information previously stored about said customer.

57. The method of claim 55, wherein the step of said first function further comprising the step of: customizing said presentation by information previously stored about at least one product purchased by said customer.

58. Said presentation created by said first function, as a product of the process of claim 55.

59. A second function creating at least one cluster that specifies demographics;
wherein said customer of claim 42 has at least one of said demographics; and
wherein said means for selecting further includes means for selecting said presentation based upon said demographics of said customer matching said demographics of at least one of said clusters.

60. Said second function of claim 59, further comprising the step of: deriving said cluster by information previously stored about said customer.

61. Said second function of claim 59, further comprising the step of: deriving said cluster by information previously stored about at least one product purchased by said customer.

62. Said cluster created by said second function as a product of the process of claim 59.

63. The method of claim 42, further comprising the step of: said customer interacting with the purchasing transaction.

64. The method of claim 42, further comprising the step of: said customer interacting with the payment transaction.

65. Said electronic presentation provided by said electronic display device to said customer in said retail environment, as a product of the process of claim 42.

66. Said presentation made available as said electronic presentation to said processing system, as a product of the process of claim 42.

67. Said electronic display device of claim 42, implementing the means for providing said electronic presentation to said customer in said retail environment.

68. A program system comprising of at least one program step residing in a memory accessibly coupled to a computer at least partly implementing at least one of the steps of claim 42.
